(19) United States
(12) Patent Application Publication
(10) Pub. No.: US 2010/0250643 A1
(43) Pub. Date: Sep. 30, 2010

(54) Platform for Societal Networking

(75) Inventors: Tammy L. Savage, Seattle, WA (US); James A. Holt, Issaquah, WA (US); David L. Waldrop, Potomac, MD (US); Christopher E. Mitchell, Snoqualmie, WA (US); Miten Navnitrai Mehta, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/411,415

(22) Filed: Mar. 26, 2009

(51) Int. Cl. G06F 15/16

(52) U.S. Cl. 709/202; 709/206

(57) ABSTRACT

Described is a technology in which a platform unifies various social network and alerting mechanisms to provide a relationship-based communication network. An affiliation service allows organizations and individuals to connect, grant permissions and share useful information about themselves in the form of relationship-based and other attributes. A publishing service routes that information to the correct recipients, including by matching desired attributes to attributes of clients recipients. A data exchange service facilitates reporting, routing, monitoring and responding to such information, as well as providing relevant external data feeds to clients. In this manner, users and organizations are able to more easily connect and work together to resolve societal problems via a single platform that facilitates user and organizational participation.

### BACKGROUND

There are a large number of Internet services that facilitate and enable communication and social interaction between users, including social networking sites and social messaging services. There are also alerting systems from organizations to subscribers (such as reverse 911), and information sources (news feeds, blogs, aggregators and so forth).

Because of such technologies, society is sometimes able to work together to solve problems. However, the use of such technologies is limited. For example, these systems provide numerous interrelationships, yet do not tend to leverage their users' expertise, engagement and capacity.

At the same time, the kinds of problems society needs to solve are often far more complex than those that can be handled with contemporary tools and technologies. Many types of societal challenges, such as responding to natural disasters or learning about diseases, for example, benefit from participation among a vast and decentralized web of people and organizations. However, there is rarely a single authority, a clear hierarchy, or one specific place where decisions are made, nor is there any apparent mechanism in place with respect to how people and organizations can participate together to respond to solving such challenges.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a platform unifies various social network and alerting mechanisms to provide a relationship-based communication network. In one aspect, an affiliation service collects user attributes and communication device/program (endpoint) preference data. A publishing service sends messages from sender endpoints to one or more recipient endpoints based upon related attributes. To send the message, the publishing service references the endpoint preference data of each recipient user to send the message to an endpoint specified by that recipient user. Further, a data exchange service allows users to send reports (information entered into predefined forms), and receive information feeds based on the individual attributes of each user.

In one aspect, the publishing service processes a message from a sender, such as an organization, that identifies desired attributes. The affiliation service accesses the user profile data to select recipient users based upon the desired attributes from the sender and the attributes associated with the users. Further, the affiliation service accesses the user preference data of each recipient user to determine an endpoint set (one or more endpoints) associated with that recipient user, and routes the message to each recipient user via each endpoint in each recipient's endpoint set.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing an example platform for societal networking based upon relationships among clients as managed and leveraged by various services.

FIG. 2 is a block diagram showing an example affiliation service by which registered users (which include organizations) may affiliate (create relationships) with each other via the platform to exchange messages and other information.

FIG. 3 is a block diagram showing an example publishing service by which users may send messages to others and reply to such messages.

FIGS. 4A and 4B comprise a block diagram showing an example data exchange service by which users may send reports to organizations and receive relevant data feeds from external sources. These external feeds can include feeds published by organizations.

FIG. 5 is a flow diagram showing some example steps that may be taken by an affiliation service to register users and invite others to register.

FIG. 6 is a flow diagram showing some example steps that may be taken by a publishing service to send communications (messages and replies) to other users

FIG. 7 is a flow diagram showing some example steps that may be taken by a data exchange service when sending reports to organizations.

FIG. 8 is a flow diagram showing some example steps that may be taken by a data exchange service to send data feeds to relevant users when received from external sources.

FIG. 9 shows an illustrative example of a computing environment into which various aspects of the present invention may be incorporated.

### DETAILED DESCRIPTION

Various aspects of the technology described herein are generally directed towards a platform that in general unifies aspects of social networking, alerting services, information contribution and subscriptions, and other such communication and data systems. As will be understood, such a unified platform provides numerous benefits, including creating situational awareness for individuals and organizations as well as facilitating the ability of organizations and/or individuals to establish trusted relationships (affiliations) and use those affiliations to effectively work together in times of need.

It should be understood that any of the examples described herein are non-limiting examples. For example, one described implementation separates an exemplified platform into various services, however some or all of these services may be combined, or further separated into additional separate services. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in societal networking and data communication in general.

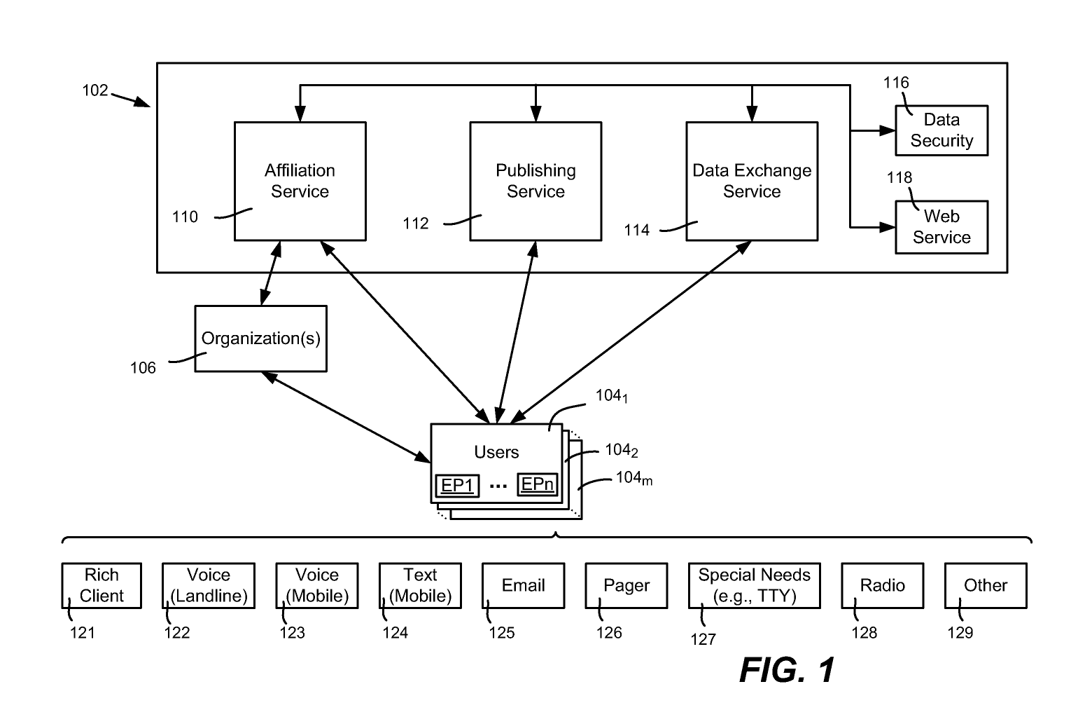

FIG. 1 shows one example implementation of a societal networking platform 102, which may be implemented as one or more services residing in one or more datacenters. In general, clients 104₁-104ₘ, whether directly as individuals or through one or more organizations 106, communicate with the platform 102 using one or more communication devices, or endpoints. In FIG. 1, the users 104 are shown as having endpoints EP1-EPn, which may be any one or combination of the communication devices 121-129. Example communication devices shown in FIG. 1 include a rich client 121 (e.g., a computer system or game console), a landline voice telephone 122, a mobile telephone 123, a mobile text device 124, an email application 125 (e.g., attached to a rich client or mobile device), a pager 126, a special needs device 127 (e.g., TTY), and a radio 128. Any other suitable device, including those not yet in existence, is represented by block 129.

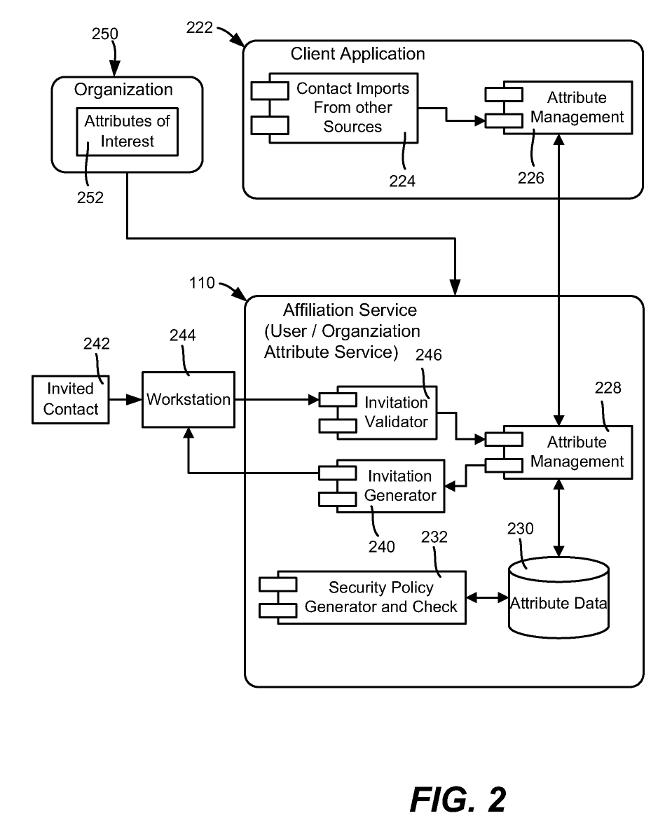

As generally represented in FIG. 1, the described platform 102 includes an affiliation service 110 which generally works with user attribute data, e.g., to obtain and manage attribute data for registered users. This data may include but is not limited to attributes or data about users, organizations, data sources and analytical tools. These data may be expanded to include items such as competency, specialty and reputation. These data or attributes may be used for identification, authorization, cataloging, reputation and mapping of users, organizations, data sources or tools. Note that a user may be an individual user as a person and/or a user or group as part of an organization, or may be an organization itself. A publishing service 112 provides a way for users to send and receive messages (alerts) to and from others, including by processing, storing and forwarding messages. A data exchange service 114 allows users to send reports to appropriate entities (including organizations) and/or receive customized information feeds (e.g., local events, public safety announcements, community action and so forth) based on their relevant information, e.g., their registered profile and/or location. Each of these services is described below with reference to FIGS. 2, 3, 4A and 4B.

Also shown in FIG. 1 is a data security component 116 (an example of which is described below), which in general provides support for the other services. Note that each service may have its own instance of the data security component 116 or another security component appropriate for its particular operations. The web service 118 represents one or more front ends for external connectivity/data access by client applications to each of the other services, e.g., residing in one or more remote data centers.

One implementation of an affiliation service 110 is generally represented in FIG. 2. In general, via the affiliation service 110 users register with the platform 102 (FIG. 1), and each creates a profile of attributes by inputting personal information such as email, landline or mobile phone numbers, as well as their locations (e.g., addresses at home and at work) as places of interest. Organizations may input additional information pertaining to that organization, such as attributes of interest, data sources as well as provide additional attributes related to that organization. Note that while some attributes are self-designated, others may be designated by another entity (e.g., an employer) or may be derived from available components of the system (e.g. current location from device, presence from system activity, and so forth), and as described below any attribute may be verified by an appropriate party.

Each user, as represented by the client application 222, may then create a personal network of contacts or affiliates (which are also (or will be) established profile entities in the system) by importing or inputting their contacts information 224 into a client-side attribute management component 226, which is coupled to (e.g., synchronizes with) an attribute management component 228 of the affiliation service 110. To facilitate entry, the affiliation service 110 enables users to retrieve and import the contacts information 224 from other social networks and email address books, using various application programming interfaces or the like.

As shown in FIG. 2, the attribute management component 228 processes and maintains the attribute data of the users, organizations and contacts in an attribute data store 230 or the like. As described below, the data is subject to security policies and checks, as represented in FIG. 2 by the block 232.

When a user signs up with the affiliation service 110 and the user's information and network of contacts is collected, an invitation generator 240 of the affiliation service 110 invites others identified in those contacts to join. In other words, the affiliation service 110 sends an invitation to join and become a contact of a particular requesting user. This is represented in FIG. 2 by the invited contact 242, who receives and responds to the invitation via a workstation 244 or other suitable device. Note that an invited contact may respond by one mechanism (e.g., a telephone) that is different from the mechanisms (e.g., email) by which the invitation was received.

If the invited contact 242 accepts, that person registers to provide his or her personal information, whereby the invitations propagate to increase the number of participating users. Along with providing the information, e.g., as a set of attributes about himself or herself, the invited contact 242 specifies endpoint preferences, a set of affiliations with others and/or a set of affiliations with organizations, (e.g., an employer, a volunteer group, and so forth). In general, attributes are data elements that indicate relationships, subject to permissions, with another entity. An example of an attribute may be “neighbor” and/or “daughter” and so forth. Note that some attributes may be pre-defined, e.g., a zip code field that indicates relationships with others and places geographically.

Any attribute provided by an invited user (or a new user) may be subject to validation, as represented in FIG. 2 by the invitation validator 246. For example, if a contact indicates that he is a volunteer with some organization; that organization may validate whether the contact actually is what he claims to be. Telephone numbers and address information may be validated via various existing directory services, for example.

With respect to the endpoint communication devices, a user may designate preferences regarding a preferred channel for communication. In doing so, endpoints may be designated and/or arranged for receiving communications in any number of ways. For example, a recipient user may specify that both a text message and an email message be used when a sender sends a message. Instructions as to how to handle a certain condition may accompany an endpoint, e.g., first call a cellular telephone, but if not answered, leave a voice message and also send an email message. Further, a contact may specify that one set of (one or more) endpoints be used with one type of emergency, while another set be used for another. For example, a work-issued pager may be designated as the endpoint for emergency communications sent from a particular corporate sender, whereas personal type emergency messages are to be first sent to a cellular telephone; public emergencies (e.g., a tornado warning) may be designated for sending to all registered endpoints, and so forth.

In addition to individual contacts, a user may also affiliate with organizations, and grant permissions regarding what profile attributes those organizations can see or use for generating alerts and/or publishing information. Each organization, represented by block 250, can define the set of attributes 252 in which that organization is interested. For example, a large organization that helps during emergencies may be interested in knowing the zip codes of each of its volunteers as well as what skill sets (e.g., trained in CPR) and blood type each volunteer has, so that in an emergency those volunteers that are nearby geographically and can help with a particular problem may be automatically contacted, via a straightforward filtering operation.

Further, an attribute-defined affiliation/relationship connection may be with an object or a topic. For example, a user may have a relationship with her daughter's car that is coupled to a satellite monitoring service, so that the user is automatically notified if something happens to that car. A user may also indicate a relationship with a topic, e.g., so as to receive messages/news regarding relevant areas of interest, as described below.

The affiliation service 110 thus makes the platform 102 unlike alerting systems and services available today, (in which users must discover, register and maintain personal information with multiple providers; in which organizations and agencies issuing emergency or life safety alerts can only reach the small audience of people who register to receive alerts; and (unlike reverse 911) cannot target a specific set of people based on attributes other than geography and telecommunication devices (cellular and landline telephones). Instead, interactivity and information exchange between individuals, organizations and even objects is available, and users only receive information that is personally relevant or useful to them. Further, because personal emergencies are handled by one platform, users need not remember nor use multiple methods to notify friends and family during emergencies.

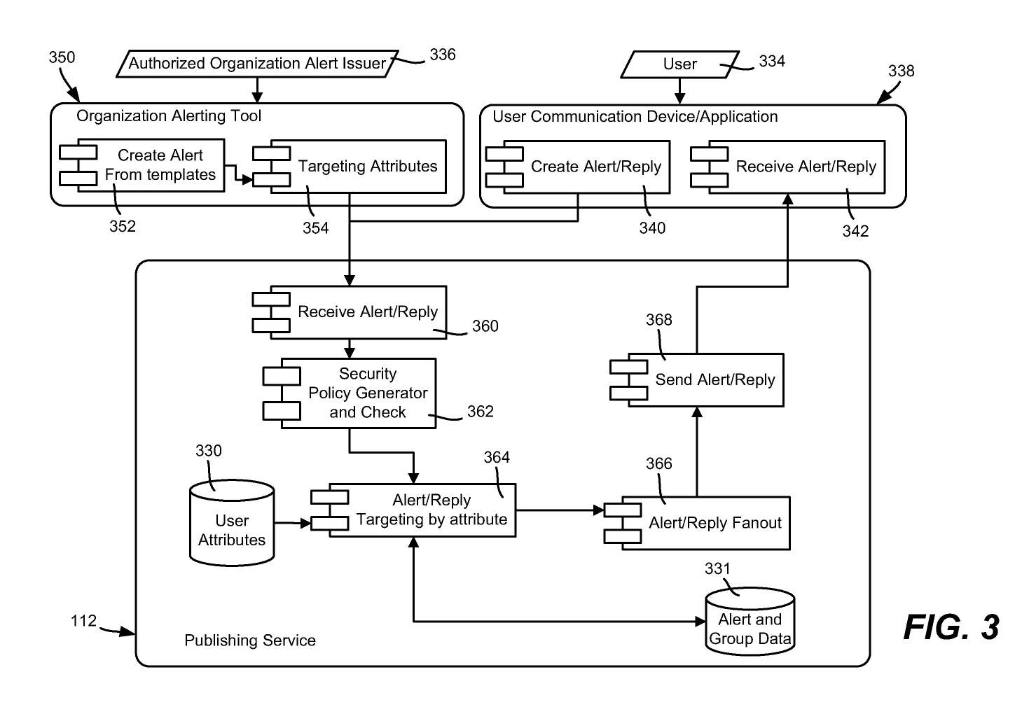

Turning to information publishing as represented in FIG. 3, in general (and among other operations), the publishing service 112 of FIG. 3 performs message routing based on the sender's and/or recipients' preferences. More particularly, via the publishing service 112, a user 334 or organization (an authorized organization alert issuer) 336 may send a message (alert) to one or more affiliated emergency contacts from any registered communication channel.

In FIG. 3, the user 334 is shown as accomplishing this via any suitable user communication device or application 338 and its accompanying create alert/reply component 340. Note that the communication device or application 338 is also configured to receive messages and replies in response to messages, as represented by the receive alert/reply component 342.

Registered alert issuing organizations (block 336) may send alerts by targeting profile attributes as registered by users. To this end, the organization sends alerts via a tool 350 or the like, and may create an alert via templates 352. The alert is sent along with specified targeting attributes 354 that determine who will receive the alert, e.g., only those that live or work in a certain zip code, as generally described above. As can be readily appreciated, this facilitates precise targeting of alerts based on matching an organization's desired attributes with each user's registered attributes.

Further, organizations may receive replies and/or request information back from individuals. This facilitates follow-ups, e.g., if an evacuation is requested, the organization can ask for a response to ensure that the message was received, as well as get a response indicating who needs help.

Whether sent by an organization or user, the publishing service 112 receives the alert message via component 360. The alert is subject to security policy and checks via component 362, that is, the message of a user or the profile attributes and values that a particular alert issuer can target may be controlled by security policy maintained within the service. If the alert passes security (meets security policy), an alert/reply targeting component 364 reads the profile attributes and other data from data stores 330 and 331 (which may correspond at least in part to the data store 230 of FIG. 2), including to determine recipient preferences, as well as possibly filter out non-matching targets.

Components 366 and 368 send (or broadcast) the alert, where it is received by the appropriate target client recipient(s), according to the preferences specified by each target of the target set, that is, the message alert is automatically forwarded to the preferred communication endpoint channel or channels of each contact. For example, the user may send a text message to a recipient, which via text-to-speech is sent to a mobile telephone because that is what the recipient has specified as an endpoint preference.

In one aspect, privacy is provided, in that the recipient does know how the message was sent, while the sender does not know how the message was received. Note that the sender can receive a reply or other acknowledgement on whatever endpoint channel the user has specified for the reply (independent of how the recipient responded). Further, the sender may not necessarily know who the recipient is, that is the publishing service provides isolation. By way of example, a user can register for information alerts related to a medical condition, without revealing that medical condition, such as to register as having asthma, and automatically get bad air quality alerts without the sender knowing who is receiving the alerts.

In sum, an alert conversation subsystem comprising the above-described components is responsible for processing (matching of user attribute values with the targeting criteria), storing and forwarding messages sent to clients comprising emergency contacts. Alert senders are verified and their rights are validated, emergency contacts and communication channels are retrieved, and the alert is delivered via the communication endpoint subsystem.

With respect to replies, if a recipient client (e.g., emergency contact) replies, the alert conversation subsystem is similarly responsible for processing, storing and forwarding the response to the other endpoints in the conversation Alerts that are sent may be archived, including for access by authorized users via an interface of the public web service 118 (FIG. 1).

Other aspects of the publishing service 112 include that an alert message may be sent to an individual or a defined group. For a group, each recipient in the group gets the alert according to his or her own preference, e.g., in a “family” group, the “mom” contact may receive the alert over a landline telephone, while a “son” contact may receive the alert over an Xbox game system.

Further, not only may a sender send a one-to-many alert, but the sender can designate how a reply, if any, is to be received, e.g., reply or reply all. The reply all designation allows coordination of help by others, rather than relying on the one who sent message, and may be the person in need of help. For example, if the alert indicates that a user is taking his wife to the hospital, the other users can coordinate who will pick up their kids from school, who will let the dog out, and so forth. In the case of an organization alert such as an evacuation notice, reply all would not be appropriate.

Note that the reply may be received on the same device on which the original message was sent. For example, if the sender sends a text alert and one recipient receives a phone call and by phone replies that the alert was received (e.g., presses ‘1’), the sender gets a text reply back; however another endpoint may receive the reply in addition to the endpoint that sent the original message.

The publishing service 112 also handles other situations as designated by a sender of an alert. For example, a sender may specify that an alert is to be sent to recipient A, but if recipient A does not respond within a certain time limit, then the alert is to be forwarded to another recipient, recipient B, and so on. Any such contingent recipient likewise may be an individual or a group. Another example is that if the recipient does not respond within a certain time then the alert would be re-sent. For organizational alerts a reply may trigger an additional alert for limited interactivity with the user.

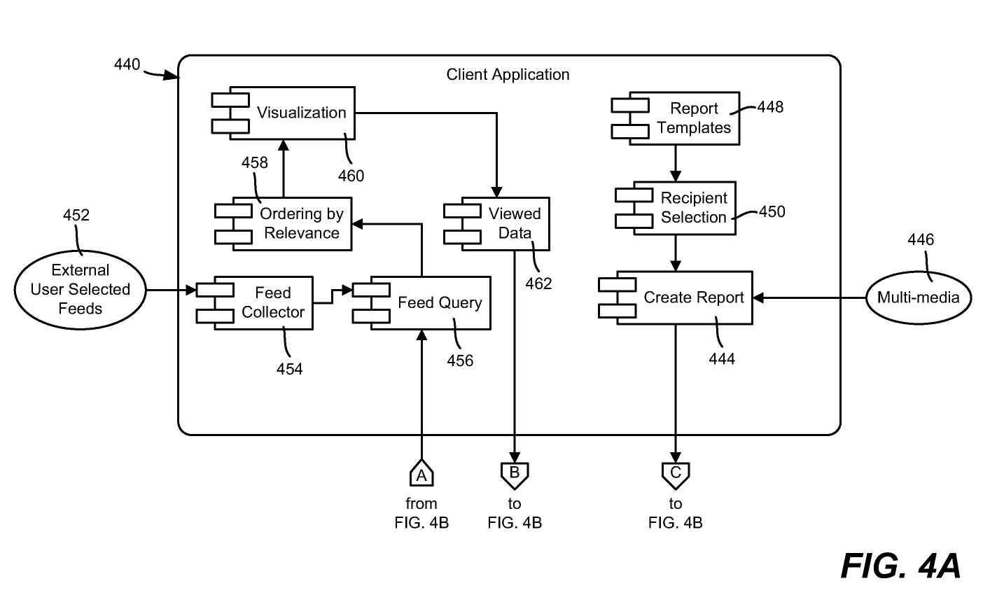

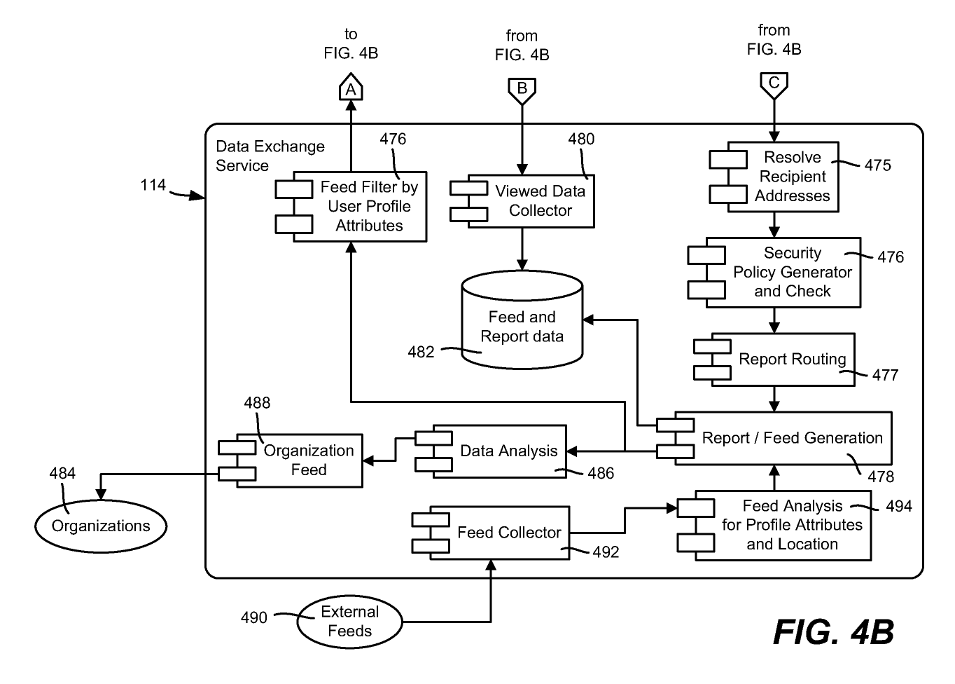

FIGS. 4A and 4B shows interaction between a client application 440 (FIG. 4A) and the data exchange service 114 (FIG. 4B). In general, the data exchange service 114 allows users to send reports to interested recipients, and receive customized information feeds (e.g., regarding news alerts, local events, public safety announcements, community action and so forth) based on their registered profile. The data exchange service 114 thus provides intelligent routing, somewhat similar to the data publishing service's routing aspects.

In the client application 440, the user may create a report 444 which can contain multimedia attachments 446 (e.g., graphics, text or pictures). A user may use templates 448 to build the report. Via component 450, the user may designate which contacts and/or relevant organizations are to receive this report, and upload this report to the data exchange service 114.

As described below, the data exchange service 114 may provide feeds to the client application 440 from various external data sources. Note that the client application 440 may also collect its own feeds, as indicated in FIG. 4A via blocks 452 and 454. Components 456 and 458 can order such feeds by relevance for viewing via a visualization component 460 as viewed data 462.

The viewing may be part of a rich client experience, such as via visualization (including but not limited to map views, list views, timeline views and the like) of the aggregated data sources and information feed for feeds. Note however that the client shown in FIG. 4A is only an example that applies to a rich client; a client may receive data by any endpoint and in any format, such as a simple voice or text message. Further, in the context of what the user is viewing in the application, the user may upload the viewed data 462 to the data exchange service 114, such as for access by others.

Turning to FIG. 4B and report processing, when a report is received at the data exchange service 114, components 475-478 process and route the report to the correct recipient. Note that via logic and the information in the data exchange service 114, the user does not necessarily have to know the address or endpoint of an organization recipient. One example of such an organization is a local police department; the user may want to send them a report, such as of suspicious activity in the neighborhood that was witnessed, and may do so simply by specifying “police department” or the like rather than by needing to specify exact contact information. Another example is a local utility company. A user may want to send them a report, including a picture such as an image of a tree leaning on sagging utility line. The user may not necessarily know the exact recipient, but in general knows the local utility company is likely responsible for the jurisdiction in which the user is located and determines the specific organization associated with the generic local utility company designation. Note that location accompanying the report may be determined automatically from GPS data, cellular tower data and so forth (which may be automatically added as metadata), and in some instances the location may be determined by processing the image.

Recipient addresses are resolved, possibly including determining which entity corresponds to a location, as described above. Security and routing are also performed, before generating (e.g., formatting) the report and sending it (block 478) for reception by each recipient. The report data, as well as any collected viewed data 480, are recorded in a data store 482. Note that any report or other data intended for a recipient client entity 484 may first be analyzed (block 486) before being fed (block 488) to the recipient client entity 484(organization or multiple organizations).

As described above, reports may be semi-structured or structured based on templates 448 (FIG. 4A), and such templates can be customized by a sender or provided by recipients. In general, a report may have an associated metadata structure, which may be arranged in a data stream format to facilitate automated, computerized analysis, so that a system may process the message. Note that thousands or millions of such messages may be received by an entity, making manual processing impractical.

Further, after sending a report, a matching process may be performed to generate a list of who else may be interested in knowing about the report, e.g., local media, the police department or anyone else who was not a directly intended recipient but has registered an interest in receiving such information. This list is returned to the sender, whereby the sender has an opportunity to choose which if any of them (or all) gets to see a copy. The sender may first check each requesting entity's reputation, profile data, and so forth.

Further, the data exchange service 114 may handle compensation. By way of example, a corporation may pay for a copy of such information, or offer to pay for additional information, and indicate the amount to a potential sender. For example, a sender may send a message that a child is going to miss school because of a certain medical condition; a company that is planning to study that condition may offer to pay for data/test cases. The sender may then choose to send the copy and/or further look into the offer.

Turning to feed-related aspects of the data exchange service 114, multimedia and multiple communication channels are supported that allow clients to receive relevant and timely information (but not other information) via the data exchange service 114. As a result, information publishers that provide external feeds 490 can reach specific users by targeting specific profile attributes such as location, profile or the context of the information, and the data exchange service 114 can recommend or filter content based on relevance. Feeds may be collected (block 492) and matched to each user's profile attributes and location (block 494) to determine whether the user is interested in each feed. The feed may be further filtered (block 476).

By way of example, relevance and filtering allows a user to receive geo-tagged news feeds (corresponding to an x-mile radius of the user's home), topic-based news feeds (e.g., containing keywords in which pharmacists are interested), and so forth. Recommendations may be based upon a user's contacts (e.g., feeds they have received) in addition to the user's profile data.

Turning to aspects related to security, the platform validates attributes as described above, and also checks security policy with respect to each data communication (although some types of replies need not be checked). Appropriate security policies are automatically generated from the attributes as well as can be set by communication authors. These policies are enforced regardless of the method of access to the system, (although a method of access may specifically be part of a security policy, e.g., a certificate may be required to change certain information).

One type of policy-based security allows a client to designate another user or set of users to perform work on his or her behalf. Such a rich delegation model is particularly useful in governmental organizations, where a chain of authority is typically well-defined, yet personnel assignments regularly change. Via policies, an organization may set up and maintain its own delegation chain, so that an appropriate authority is available. Note that the organization sets up the delegation model which it best knows how to maintain, and not the service which only verifies whether the requesting person can do what is being requested.

In one implementation, a policy-based data security system is based upon Microsoft Corporation's SECPal technology. In general, for each call to the data access layer, to secure data access a SECPal rules engine verifies that the request is in policy compliance. Note that while security policies are often generated from static data (e.g., existing attributes), the security system may dynamically generate security policies, such as based upon the current user's context, what type of data is being requested and what operation on that data is being performed. Additional security can be provided by data encryption with the key only provided to users with certain attributes. A policy may be used to enforce this.

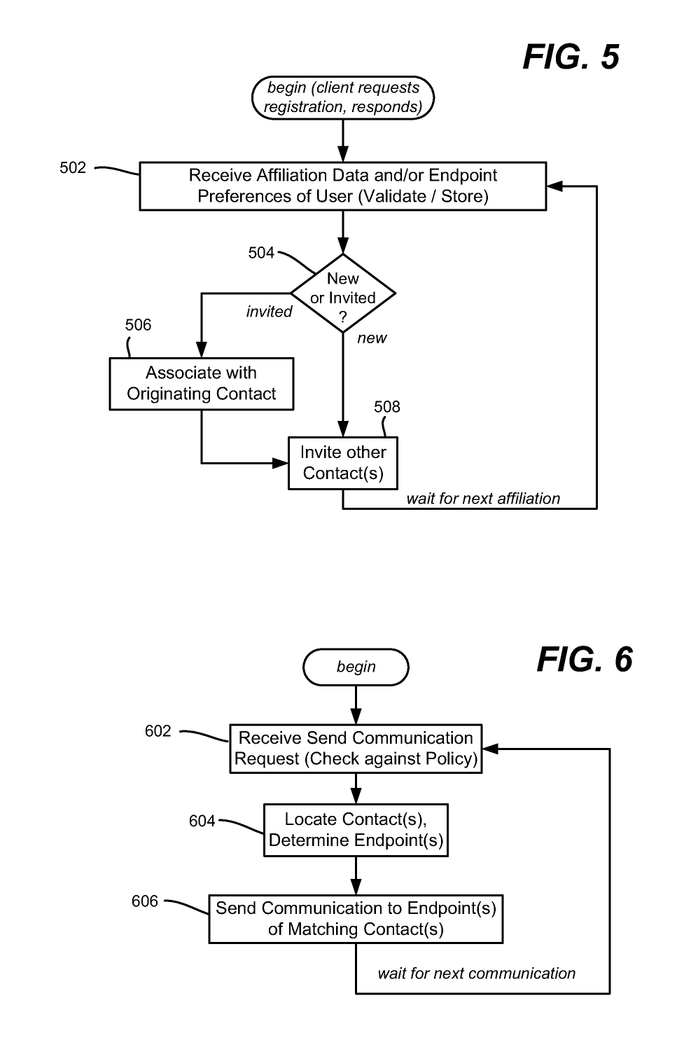

By way of summary, FIGS. 5-8 represent some of the various example steps and operations that the services may perform. FIG. 5 represents the affiliation service's general steps related to registration, beginning at step 502 where affiliation data and/or endpoint preferences of a client are received with respect to a registration request. Step 502 also represents validating some or all of the client-provided data, and if valid, storing that data for this client.

Step 504 represents determining whether the registration is for a new client, or one that was invited. If invited, step 506 associates the client with the client that initiated the invitation by naming the contact. Step 508 represents inviting other contacts as specified by the now registered-client. Note that an existing client may be invited to become another client's contact, in which event, the association is made at step 506, however the existing client data may only be updated and validated to the extent it changed.

FIG. 6 represents the publishing service processing a communication request, which may be an alert message or a reply, and may be from an individual or organization. In general, the communication is received at step 602, and the communication evaluated against security policy checks. If passed, the contact or contacts are located (the designated target or targets if sending, the original sender if replying) at step 604. Step 606 sends the communication to the appropriate endpoint (or endpoints) as registered by each contact.

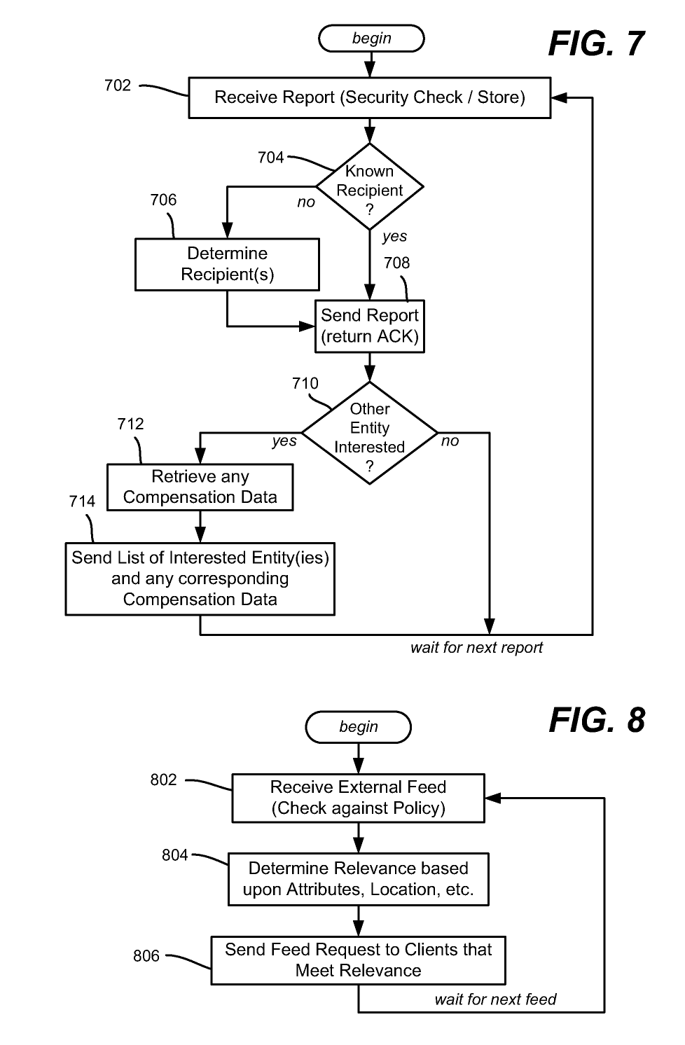

FIG. 7 is directed towards the report handling aspects of the data exchange service, beginning at step 702 where a report is received from a sender and security checked; the report is stored if passed. Step 704 evaluates whether the recipient of the report is known directly, or needs to be determined, such as via location-based lookup (as in the local utility example set forth above). Step 708 sends the report, and assuming properly received by the designated recipient, also represents returning an acknowledgement of receipt, which, for example may include the identity of the recipient entity that was determined.

As also described above, another entity may be interested in receiving the report. If so, steps 712 and 714 are performed, to determine whether the other entity is offering compensation, and in any event, to return a list of one or more interested entities (with any compensation offering) to the sender. The report sender may thereby decide whether to send a copy to a listed entity.

FIG. 8 shows example data feed steps of the data exchange service. Step 802 represents receiving the feed, and step 804 determining the relevance of that feed to each client. As described above, the relevance may be based on the attributes and/or location of the client, as well as any number of other criteria, e.g., time of day, reputation of sender, size or type (e.g., graphics will not be sent to a text-only device) and so on. Note that the endpoint that is selected may be dependent on the content type. Step 806 represents sending the feed to client recipients that consider this feed relevant based upon the above evaluation.

### Exemplary Operating Environment

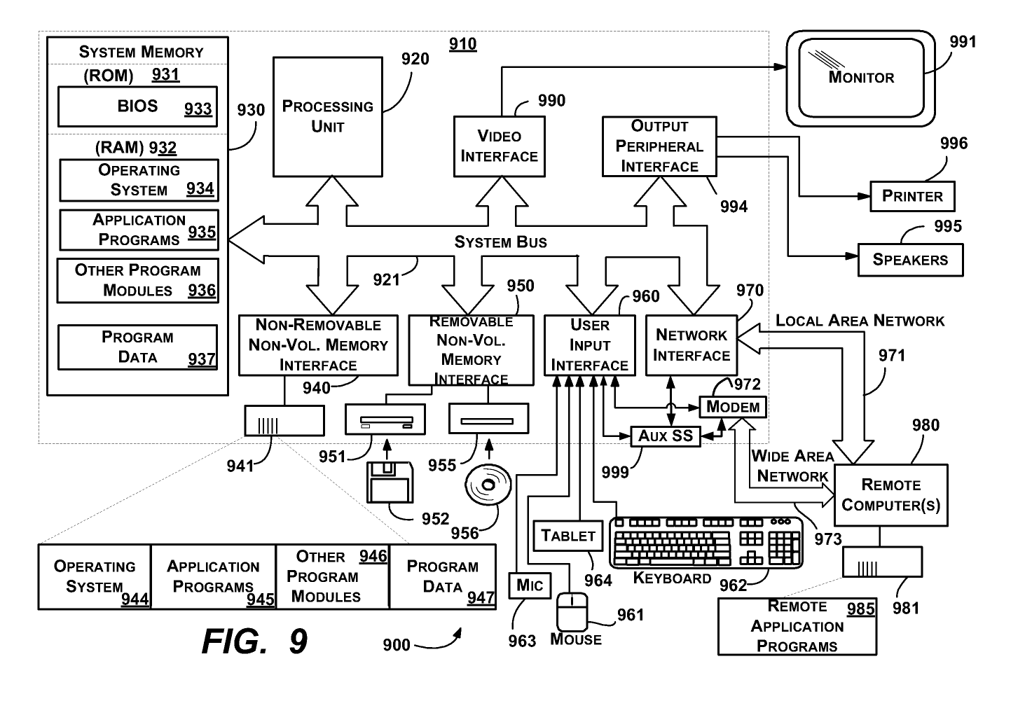

FIG. 9 illustrates an example of a suitable computing and networking environment 900 on which the examples of FIGS. 1-8 may be implemented. The computing system environment 900 is only one example of a suitable computing environment and is not intended to suggest any limitation as to the scope of use or functionality of the invention. Neither should the computing environment 900 be interpreted as having any dependency or requirement relating to any one or combination of components illustrated in the exemplary operating environment 900.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 9, an exemplary system for implementing various aspects of the invention may include a general purpose computing device in the form of a computer 910. Components of the computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 910 typically includes a variety of computer-readable media. Computer-readable media can be any available media that can be accessed by the computer 910 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 910. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936 and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media, described above and illustrated in FIG. 9, provide storage of computer-readable instructions, data structures, program modules and other data for the computer 910. In FIG. 9, for example, hard disk drive 941 is illustrated as storing operating system 944, application programs 945, other program modules 946 and program data 947. Note that these components can either be the same as or different from operating system 934, application programs 935, other program modules 936, and program data 937. Operating system 944, application programs 945, other program modules 946, and program data 947 are given different numbers herein to illustrate that, at a minimum, they are different copies. A user may enter commands and information into the computer 910 through input devices such as a tablet, or electronic digitizer, 964, a microphone 963, a keyboard 962 and pointing device 961, commonly referred to as mouse, trackball or touch pad. Other input devices not shown in FIG. 9 may include a joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. The monitor 991 may also be integrated with a touch-screen panel or the like. Note that the monitor and/or touch screen panel can be physically coupled to a housing in which the computing device 910 is incorporated, such as in a tablet-type personal computer. In addition, computers such as the computing device 910 may also include other peripheral output devices such as speakers 995 and printer 996, which may be connected through an output peripheral interface 994 or the like.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include one or more local area networks (LAN) 971 and one or more wide area networks (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960 or other appropriate mechanism. A wireless networking component 974 such as comprising an interface and antenna may be coupled through a suitable device such as an access point or peer computer to a WAN or LAN. In a networked environment, program modules depicted relative to the computer 910, or portions thereof, may be stored in the remote memory storage device. By way of example, and not limitation, FIG. 9 illustrates remote application programs 985 as residing on memory device 981. It may be appreciated that the network connections shown are exemplary and other means of establishing a communications link between the computers may be used.

An auxiliary subsystem 999 (e.g., for auxiliary display of content) may be connected via the user interface 960 to allow data such as program content, system status and event notifications to be provided to the user, even if the main portions of the computer system are in a low power state. The auxiliary subsystem 999 may be connected to the modem 972 and/or network interface 970 to allow communication between these systems while the main processing unit 920 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a system comprising, a platform by which clients communicate messages, including an affiliation service that collects client attributes and endpoint preference data that includes client relationships with at least one other affiliates, a publishing service that sends a message from a sender client to at least one recipient client, the publishing service referencing the endpoint preference data of each recipient client to send the message to an endpoint of that client as specified in the endpoint preference data, and a data exchange service by which clients send reports, and receive content based on the attributes of each client.

2. The system of claim 1 wherein the attributes collected by the affiliation service includes attributes that define a relationship with another individual client, an organizational client, an object, or a topic, or any combination of another individual client, an organizational client, an object, or a topic.

3. The system of claim 1 wherein the affiliation service further collects contact information from a client related to at least one other contact, the affiliation service including an invitation mechanism that uses the contact information to invite each other contact to affiliate via the platform by providing corresponding attributes and endpoint preference data.

4. The system of claim 1 wherein the sender client comprises an organization, and wherein the publishing service sends a message from the organization to target client recipients based on matching attributes identified by the organization to attributes of each recipient client.

5. The system of claim 1 wherein the publishing service includes a mechanism by which a recipient client replies to the sender client.

6. The system of claim 1 wherein the publishing service includes a mechanism by which a recipient client replies to the sender client and any other recipient client that received the message from the sender client.

7. The system of claim 1 wherein the publishing service maintains group information corresponding to a plurality of recipient clients, and wherein the sender client sends the message to the plurality of recipient clients by identifying the group to the publishing service.

8. The system of claim 1 wherein the affiliation service includes a security mechanism that validates received attribute data, wherein the publishing service includes a security mechanism that ensures that the sender client and message meet security policy, and wherein the data exchange service includes a security mechanism that ensures that a report and client issuer of the report meet security policy.

9. The system of claim 1 wherein the publishing service or the data exchange service, or both the publishing service and the data exchange service include means for delegating an entity to act on behalf of the sender client.

10. The system of claim 1 further comprising at least one template for generating a report, and further comprising means for generating the report in a format that is configured for automated processing.

11. In a computing environment, a method comprising:
receiving affiliation data from a client, including attributes related to communicating with the client, and contact information related to communicating with another client;
inviting another client that was identified in the contact information to provide other affiliation data, and in response, receiving other affiliation data from the other client, the other affiliation data including attributes and endpoint preference data;
receiving a request to send a message from the client to the other client;
determining an endpoint for sending the message to the other client based on the endpoint preference data; and
sending the message from the client to the other client via the endpoint.

12. The method of claim 11 further comprising, receiving a reply from the other client, determining a reply receiving endpoint for sending the reply to the client, and sending the message from the other client to the client via the reply receiving endpoint.

13. The method of claim 11 further comprising, selecting the other client to receive the message based upon desired attributes provided by a sender and attributes corresponding to the other client.

14. The method of claim 11 further comprising, receiving a report from a report sender, determining an intended recipient based on information accompanying the report, and sending the report to that report recipient.

15. The method of claim 14 further comprising, determining that another entity is interested in the report, and identifying the other entity to the report sender to provide the report sender with an opportunity to send a copy of the report to the other entity.

16. The method of claim 14 further comprising, indicating to the report sender that another entity is offering compensation related to the report.

17. In a computing environment, a system comprising, a publishing service that is coupled to client profile data including attributes and client preference data, the publishing service configured to:
process a message from a sender that identifies desired attributes;
access the client profile data to select recipient clients based upon the desired attributes from the sender and attributes associated with the clients;
access the client preference data of each recipient client to determine an endpoint set associated with that recipient client; and
route the message to each recipient client via at least one endpoint of the endpoint set determined for that client.

18. The system of claim 17 wherein the publishing service is further configured to return replies from clients to the sender, and to route a message from one client to another client.

19. The system of claim 17 further comprising an affiliation service by which clients provide the client profile data.

20. The system of claim 17 further comprising a data exchange service by which clients send reports to a report recipient, and receive selected data feeds provided by external sources, the data exchange service matching feeds to clients based at least in part upon each client's profile data.
